(19) United States
(12) Patent Application Publication
(10) Pub. No.: US 2008/0134492 A1
(43) Pub. Date: Jun. 12, 2008

(54) POLY(ETHYLENEOXIDE) SILOXANE GEL ELECTROLYTES

(75) Inventors: Khalil Amine, Downers Grove, IL (US); Zonghai Chen, Downers Grove, IL (US); Qingzheng Wang, San Jose, CA (US)

Correspondence Address: FOLEY & LARDNER LLP, 150 EAST GILMAN STREET, P.O. BOX 1497, MADISON, WI, 53701-1497, US

(73) Assignee: UChicago Argonne, LLC

(21) Appl. No.: 11/693,420

(22) Filed: Mar. 29, 2007

Related U.S. Application Data
(60) Provisional application No. 60/869,467, filed on Dec. 11, 2006.

(51) Int. Cl. H01M 6/16; H01M 4/82; H01M 4/00; H01M 4/04

(52) U.S. Cl. 29/623.1; 429/302; 264/236

(57) ABSTRACT

Gel electrolytes are described having at least one poly(ethyleneoxide) siloxane; at least one crosslinking agent; at least one monofunctional monomeric compound; at least one salt; and at least one radical reaction initiator. Methods for the preparation of the gel electrolytes and electrochemical cells prepared with the gel electrolytes are also described.

### CROSS-REFERENCES TO RELATED APPLICATIONS

This application claims the priority to U.S. Provisional Application No. 60/869,467 filed Dec. 11, 2006, the entire contents of which are incorporated herein by reference.

### GOVERNMENT RIGHTS

The United States Government has rights in this invention pursuant to Contract No. DE-AC02-06CH11357 between the United States Government and UChicago Argonne, LLC, representing Argonne National Laboratory.

### FIELD

The present invention generally relates to the composition and assembly methods of gel electrolytes and their use in electrochemical cells. Exemplary electrochemical cells include lithium ion rechargeable batteries and capacitors. The invention particularly relates to gel electrolyte systems with high ionic conductivity using poly(ethyleneoxide) siloxanes as a conducting phase.

### BACKGROUND

The increased demand for lithium batteries has resulted in research and development to improve the safety and performance of such batteries. Many lithium batteries employ organic carbonate electrolytes associated with high degrees of volatility, flammability, and chemical reactivity. To combat such disadvantages, electrochemical cells having solid polymer electrolyte (“SPE”) systems have been the subject of research and development. SPE systems have the potential to exhibit numerous advantages. Such advantages include high energy density, high electrolyte stability, the ability to be configured in nearly any shape since the electrolyte contains no liquid, potentially inexpensive, inherent safety characteristics versus liquid electrolytes, and an expansive market if successfully developed. One of the impediments to the successful development of SPE systems, at least for room temperature operation, has been the low ionic conductivity of the SPE. For example, some batteries having solid polymer electrolytes are operated at elevated temperatures to increase the ionic conductivity of the electrolyte system.

One type of SPE is based upon poly(ethyleneoxide) (“PEO”) polymers. Batteries based on PEO polymers have been investigated. Typically, the PEO used is a high molecular weight linear analog having a semicrystalline microstructure, which forms relatively strong, free-standing films at room temperature. The PEO system may be doped with lithium ions, from sources such as lithium trifluoromethansulfonimide [LiN(CF₃SO₃)₂]. The microcrystalline structure, while imparting the strength to the films, impedes the lithium ion transport, resulting in low ionic conductivities. As a result, such systems tend to require operation at elevated temperatures, above the melting point of the PEO polymer.

A variety of polysiloxane-based electrolytes have also been developed for use as solid electrolytes. However, polysiloxane based electrolytes also typically have a low ionic conductivity and/or cycling performance that limits their use to applications that do not require high rate performance.

Materials for use in SPE systems are therefore desired which overcome the shortcomings of conventional SPE systems. Such materials will desirably have improved room temperature ionic conductivity, chemical electrochemical stability, and safety.

### SUMMARY

In one aspect, a gel electrolyte comprises: at least one poly(ethyleneoxide) siloxane; at least one crosslinking agent; at least one monofunctional monomeric compound; at least one salt; and at least one radical reaction initiator.

In some embodiments, the poly(ethyleneoxide) siloxane is a compound of Formula Ia, Ib, Ic, Id, or a mixture of any two or more thereof:

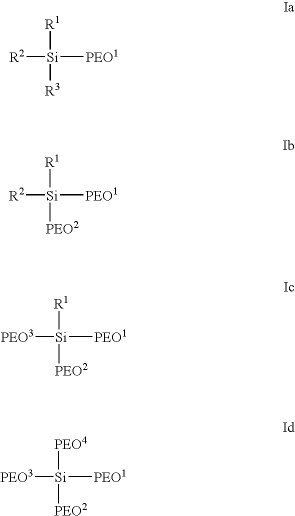

wherein

R¹, R², and R³ are each independently hydrogen, a substituted or unsubstituted alkyl group having from 1 to 12 carbon atoms, a substituted or unsubstituted alkenyl group having from 2 to 12 carbon atoms, or a group of Formula IIa, IIb, IIc, or IId;

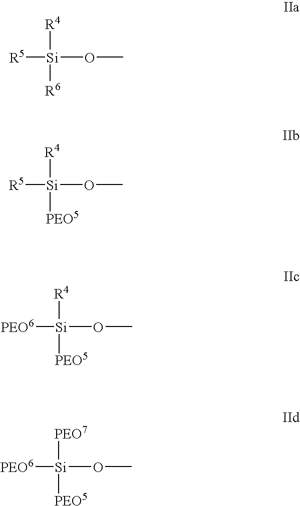

wherein,

R⁴, R⁵, and R⁶ are each independently hydrogen, a substituted or unsubstituted alkyl group having from 1 to 12 carbon atoms, or a substituted or unsubstituted alkenyl group having from 2 to 12 carbon atoms; and

PEO¹, PEO², PEO³, PEO⁴, PEO⁵, PEO⁶, and PEO⁷ are each independently a poly(ethyleneoxide) group. In some such embodiments, when the poly(ethyleneoxide) siloxane is a compound of Formula Ia and R¹ is a group of Formula IIa or IIb, then at least one of R², R³, R⁴, R⁵, and R⁶ is other than alkyl.

In some embodiments, the poly(ethyleneoxide) siloxane is a compound of Formula Ib, Ic, or Id.

In some embodiments, the PEO¹, PEO², PEO³, and PEO⁴ are each independently represented by Formula IIIa or IIIb;

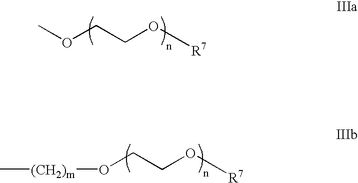

wherein

R⁷ is a hydrogen, a substituted or unsubstituted alkyl group having from 1 to 12 carbon atoms, a substituted or unsubstituted alkenyl group having from 2 to 12 carbon atoms, or a group of Formula IV;

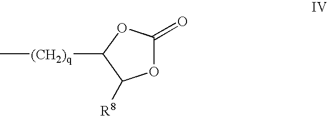

R⁸ is hydrogen, a substituted or unsubstituted alkyl group having from 1 to 12 carbon atoms, or a substituted or unsubstituted alkenyl group having from 2 to 12 carbon atoms;

m represents a whole number from 1 to 8,

n represents a whole number from 0 to 20, and

q represents a whole number from 0 to 8.

In some embodiments, the gel electrolyte further comprises a siloxanyl carbonate co-solvent. In some such embodiments, the co-solvent is 1-[1-trimethylsiloxanylethyl]ethylene carbonate.

In some embodiments, the co-solvent is present from about 0.1 wt % to about 80 wt %.

In some embodiments, the poly(ethyleneoxide) siloxane is 2-[2-[2-[2-methoxy]ethoxy]ethoxy]ethoxy trimethyl silane. In some such embodiments, the 2-[2-[2-[2-methoxy]ethoxy]ethoxy]ethoxy trimethyl silane is present from about 40 wt % to about 90 wt %.

In some embodiments, the crosslinking agent is a compound of Formula VII:

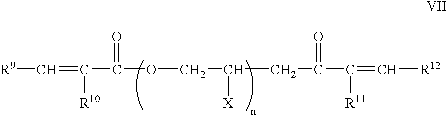

wherein,

R⁹, R¹⁰, R¹¹, and R¹² are each independently hydrogen, a substituted or unsubstituted alkyl group having from 1 to 12 carbon atoms, or a substituted or unsubstituted alkenyl group having from 2 to 12 carbon atoms;

X is hydrogen, methyl, or ethyl; and

n is a whole number from 1 to 15.

In some embodiments, the monofunctional monomeric compound is a compound of Formula VIII:

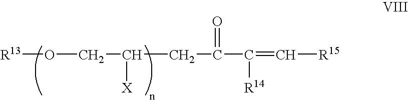

wherein,

R¹³ is an alkyl group having from 1 to 12 carbon atoms;

R¹⁴ and R¹⁵ are each independently a hydrogen, a substituted or unsubstituted alkyl group having from 1 to 12 carbon atoms, or a substituted or unsubstituted alkenyl group having from 2 to 12 carbon atoms;

X is hydrogen, methyl, or ethyl; and

n is a whole number from 1 to 20.

In some embodiments, the poly(ethyleneoxide) siloxane is present from about 5 wt % to about 95 wt %, wherein the wt % is calculated on the total weight of the at least one poly(ethyleneoxide) siloxane, the at least one crosslinking agent, the at least one monofunctional monomeric compound, the at least one salt, and the at least one radical reaction initiator. In some such embodiments, the poly(ethyleneoxide) siloxane is present from about 30 wt % to about 95 wt %. In other such embodiments, the poly(ethyleneoxide) siloxane is present from about 50 wt % to about 80 wt %.

In some embodiments, the crosslinking agent is present from about 5 wt % to about 60 wt %, wherein the wt % is calculated on the total weight of the at least one poly(ethyleneoxide) siloxane, the at least one crosslinking agent, the at least one monofunctional monomeric compound, the at least one salt, and the at least one radical reaction initiator. In some such embodiments, the crosslinking agent is present from about 10 wt % to about 40 wt %.

In some embodiments, the monofunctional monomeric compound is present from about 10 wt % to about 50 wt %, wherein the wt % is calculated on the total weight of the at least one poly(ethyleneoxide) siloxane, the at least one crosslinking agent, the at least one monofunctional monomeric compound, the at least one salt, and the at least one radical reaction initiator. In some such embodiments, the monofunctional monomeric compound is present from about 15 wt % to about 40 wt %.

In some embodiments, the at least one salt is a lithium salt. In some such embodiments, the lithium salt is LiClO₄, LiBF₄, LiAsF₆, LiPF₆, Li[PF₂(C₂O₄)₂], Li[PF₄(C₂O₄)], Li[CF₃SO₃], Li[N(CF₃SO₂)₂], Li[C(CF₃SO₂)₃], Li[N(SO₂C₂F₅)₂], a lithium alkyl fluorophosphate, Li[B(C₂O₄)₂], Li[BF₂(C₂O₄)], or a mixture of any two or more thereof.

In some embodiments, a molar ratio of the lithium salt relative to a total molar concentration of oxygen in the at least one poly(ethylene) oxide siloxane, the at least one crosslinking agent, the at least one monofunctional monomeric compound, and the at least one radical reaction initiator, is 0.01 to 0.3.

In some embodiments, the at least one salt is a tetraalkylammonium salt selected from [NR¹⁶₄][CF₃SO₃], [NR¹⁶₄][N(CF₃SO₂)²⁻], [NR¹⁶₄][BF₄⁻], [NR¹⁶₄][PF₆⁻], [NR¹⁶₄][AsF₆⁻], or a mixture of any two or more of hereof, where R¹⁶ is an alkyl having from 1 to 12 carbon atoms.

In some embodiments, a molar ratio of the tetraalkylammonium salt relative to a total molar concentration of oxygen in the at least one poly(ethylene) oxide siloxane, the at least one crosslinking agent, the at least one monofunctional monomeric compound, and the at least one radical reaction initiator, is 0.01 to 0.3.

In some embodiments, the at least one radical reaction initiator is a thermal initiator. In such embodiments, the thermal initiator is an azo compound, a peroxide compound, bismaleimide, or a mixture of any two or more thereof. In other such embodiments, the azo compound is azoisobutyronitrile. In other such embodiments, the peroxide compound is benzoylperoxide. In other such embodiments, the at least one radical reaction initiator is a photo initiator. In yet other such embodiments, the photo initiator is 1-hydroxyl-phenyl-ketone, benzophenone, 2-hydroxyl-2-methyl-1-phenyl-propanone, 2-hydroxyl-1-[4-(2-hydroxy)phenyl]-2-methyl-1-propanone, methylbenzoylformate, oxy-phenyl-acetic acid 2-[2-oxo-2-phenyl-acetoxy-ethoxy]-ethyl ester, oxy-phenyl-acetic 2-[2-hydroxy-ethoxy]-ethyl ester, α,α-dimethoxy-α-phenylacetophenone, 2-benzyl-2-(dimethylamino)-1-[4-(4-morpholinyl)phenyl]-1-propanone, diphenyl(2,4,6-trimethylthio)phenyl)-phosphine oxide, phosphine oxide, phenyl bis(2,4,6-trimethyl benzoyl), bis(eta 5-2,4-cyclopentadien-1-yl)bis[2,6-difluoro-3-(1H-pyrrol-1-yl)phenyl]titanium, iodonium (4-methylphenyl)-[4-(2-methylpropyl)phenyl]-hexafluorophosphate, or a mixture of any two or more thereof.

In some embodiments, the gel electrolyte is incorporated into a porous medium. In some such embodiments, the porous medium is a polyolefin separator, a polyolefin nonwoven type separator, or a polycarbonate microporous membrane.

In some embodiments, the gel electrolyte is formed by thermal initiation. In other embodiments, the gel electrolyte is formed by UV radiation. In some embodiments, the gel electrolyte is formed by thermal initiation followed by UV radiation. In other embodiments, the gel electrolyte is formed by UV radiation followed by thermal initiation.

In some embodiments, the gel electrolyte further comprises at least one electrode stabilizing additive. In some such embodiments, the electrode stabilizing additive can be oxidized or polymerized on the surface of positive electrodes. In other such embodiments, the electrode stabilizing additive can be reduced or polymerized on the surface of negative electrodes.

In some embodiments, the electrode stabilizing additive is pyridazine, vinyl pyridazine, quinoline, vinyl quinoline, pyridine, vinyl pyridine, indole, vinyl indole, triethanolamine, 1,3-dimethyl butadiene, butadiene, vinyl ethylene carbonate, vinyl carbonate, imidazole, vinyl imidazole, piperidine, vinyl piperidine, pyrimidine, vinyl pyrimidine, pyrazine, vinyl pyrazine, isoquinoline, vinyl isoquinoline, quinoxaline, vinyl quinoxaline, biphenyl, 1,2-diphenyl ether, 1,2-diphenylethane, o-terphenyl, N-methyl pyrrole, naphthalene, 3,9-divinyl-2,4,8,10-tetraoxaspiro[5,5]undecane, 3,9-divinyl-2,4,8-trioxaspiro[5,5]undecane, 3,9-divinyl-2,4-dioxaspiro[5,5]undecane, 3,9-diethylidene-2,4,8,10-tetraoxaspiro[5,5]undecane, 3,9-diethylidene-2,4,8-trioxaspiro[5,5]undecane, 3,9-diethylidene-2,4-dioxaspiro[5,5]undecane, 3,9-dimethylene-2,4,8,10-tetraoxaspiro[5,5]undecane, 3,9-divinyl-1,5,7,11-tetraoxaspiro[5,5]undecane, 3,9-dimethylene-1,5,7,11-tetraoxaspiro[5,5]undecane, 3,9-diethylidene-1,5,7,11-tetraoxaspiro[5,5]undecane, or a mixture of any two or more thereof.

In some embodiments, the electrode stabilizing additive is a substituted or unsubstituted spirocyclic hydrocarbon containing at least one oxygen atom and at least one alkenyl or alkynyl group.

In some embodiments, the electrode stabilizing additive is a compound of Formula IX:

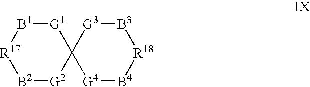

wherein

B¹, B², B³, and B⁴ are each independently O or CR¹⁹R²⁰; provided that B¹ is not O when G¹ is O, B² is not O when G² is O, B³ is not O when G³ is O, and B⁴ is not O when G⁴ is O;

G¹, G², G³, and G⁴ are each independently O or CR¹⁹R²⁰; provided that G¹ is not O when B¹ is O, G² is not O when B² is O, G³ is not O when B³ is O, and G⁴ is not O when B⁴ is O;

R¹⁷ and R¹⁸ are each independently a substituted or unsubstituted divalent alkenyl or alkynyl group;

R¹⁹ and R²⁰ at each occurrence are independently H, F, Cl, a substituted or an unsubstituted alkyl, alkenyl, or alkynyl group.

In some embodiments, the electrode stabilizing additive is 3,9-divinyl-2,4,8,10-tetraoxaspiro[5,5]undecane, 3,9-divinyl-2,4,8-trioxaspiro[5,5]undecane, 3,9-divinyl-2,4-dioxaspiro[5,5]undecane, 3,9-diethylidene-2,4,8,10-tetraoxaspiro[5,5]undecane, 3,9-diethylidene-2,4,8-trioxaspiro[5,5]undecane, 3,9-diethylidene-2,4-dioxaspiro[5,5]undecane, 3,9-dimethylene-2,4,8,10-tetraoxaspiro[5,5]undecane, 3,9-divinyl-1,5,7,11-tetraoxaspiro[5,5]undecane, 3,9-dimethylene-1,5,7,11-tetraoxaspiro[5,5]undecane, 3,9-diethylidene-1,5,7,11-tetraoxaspiro[5,5]undecane, or a mixture of any two or more thereof.

In some embodiments, the at least one salt is not Li[B(C₂O₄)₂], Li[BF₂(C₂O₄)], Li[PF₂(C₂O₄)₂], or Li[PF₄(C₂O₄)], and the electrode stabilizing additive is Li[B(C₂O₄)₂], Li[BF₂(C₂O₄)], Li[PF₂(C₂O₄)₂], Li[PF₄(C₂O₄)], or a mixture of any two or more of hereof.

In some embodiments, the electrode stabilizing additive is present from about 0.001 wt % to about 10 wt %.

In some embodiments, the electrode stabilizing additive is an anion receptor. In some such embodiments, the anion receptor is a Lewis acid. In other such embodiments, the anion receptor is a borane, a boronate, a borate, a borole, or a mixture of any two or more thereof. In other such embodiments, the anion receptor is tri(propyl)borate, tris(1,1,1,3,3,3-hexafluoro-propan-2-yl)borate, tris(1,1,1,3,3,3-hexafluoro-2-phenyl-propan-2-yl)borate, tris(1,1,1,3,3,3-hexafluoro-2-(trifluoromethyl)propan-2-yl)borate, triphenyl borate, tris(4-fluorophenyl)borate, tris(2,4-difluorophenyl)borate, tris(2,3,5,6-tetrafluorophenyl)borate, tris(pentafluorophenyl)borate, tris(3-(trifluoromethyl)phenyl)borate, tris(3,5-bis(trifluoromethyl)phenyl)borate, tris(pentafluorophenyl)borane, 2-(2,4-difluorophenyl)-4-fluoro-1,3,2-benzodioxaborole, 2-(3-trifluoromethylphenyl)-4-fluoro-1,3,2-benzodioxaborole, 2,5-bis(trifluoromethyl)phenyl-4-fluoro-1,3,2-benzodioxaborole, 2-(4-fluorophenyl)-tetrafluoro-1,3,2-benzodioxaborole, 2-(2,4-difluorophenyl)-tetrafluoro-1,3,2-benzodioxaborole, 2-(pentafluorophenyl)-tetrafluoro-1,3,2-benzodioxaborole, 2-(2-trifluoromethyl phenyl)-tetrafluoro-1,3,2-benzodioxaborole, 2,5-bis(trifluoromethyl phenyl)-tetrafluoro-1,3,2-benzodioxaborole, 2-phenyl-4,4,5,5-tetra(trifluoromethyl)-1,3,2-benzodioxaborolane, 2-(3,5-difluorophenyl-4,4,5,5-tetrakis(trifluoromethyl)-1,3,2-dioxaborolane, 2-(3,5-difluorophenyl-4,4,5,5-tetrakis(trifluoromethyl)-1,3,2-dioxaborolane, 2-pentafluorophenyl-4,4,5,5-tetrakis(trifluoromethyl)-1,3,2-dioxaborolane, bis(1,1,1,3,3,3-hexafluoroisopropyl)phenyl-boronate, bis(1,1,1,3,3,3-hexafluoroisopropyl)-3,5-difluorophenylboronate, bis(1,1,1,3,3,3-hexafluoroisopropyl)pentafluorophenylboronate, or a mixture of any two or more thereof.

In some embodiments, each anion receptor is present at a concentration of about 0.001 to about 10 wt %.

In another aspect, an electrochemical cell comprises a gel electrolyte embodied herein, and at least one electrode.

In some embodiments, the electrochemical cell is a lithium-ion rechargeable cell. In other embodiments, the electrochemical cell is a capacitor. In other such embodiments, the capacitor is a double layer electrochemical capacitor.

In another aspect, a method of preparing a gel electrolyte comprises: (1) dissolving a lithium salt and a thermal initiator in a poly(ethylene oxide) siloxane to form a first solution; (2) adding two or more acrylate terminated polyalkylether compounds to the first solution, to form a second solution wherein acrylate terminated polyalkylether compounds comprise an ethylene oxide unit, a propylene oxide unit, or both; (3) casting the second solution onto a substrate, and (4) heating the second solution and substrate until the second solution is solidified.

In another aspect, a method of assembling an electrochemical cell with a gel electrolyte, comprises: (1) coating a gel electrolyte solution onto the surface of a porous supporter, a positive electrode laminate, and a negative electrode laminate, wherein the gel electrolyte solution comprises at least one poly(ethyleneoxide) siloxane; at least one crosslinking agent; at least one monofunctional monomeric compound; at least one salt; and at least one radical reaction initiator; (2) gelling the gel electrolyte solution to produce the gel electrolyte; (3) stacking the coated supporter, the coated positive electrode laminate, and the coated negative electrode laminate to form an electrochemical cell; (4) winding or folding the electrochemical cell to prepare a spiral wound or prismatic electrochemical cell; and (5) packaging the spiral wound or prismatic electrochemical cell in a metal can, a plastic pouch, or a laminated plastic/metal foil pouch.

In another aspect, a method of assembling an electrochemical cell with a gel electrolyte, comprises: (1) coating a gel electrolyte solution onto the surface of a porous supporter, a positive electrode laminate, and a negative electrode laminate, wherein the gel electrolyte solution comprises at least one poly(ethyleneoxide) siloxane; at least one crosslinking agent; at least one monofunctional monomeric compound; at least one salt; and at least one radical reaction initiator; (2) stacking the coated supporter, the coated positive electrode laminate, and the coated negative electrode laminate to form an electrochemical cell; (3) winding or folding the electrochemical cell to prepare a spiral wound or prismatic electrochemical cell; (4) gelling the gel electrolyte solution to form the gel electrolyte; and (5) packaging the spiral wound or prismatic electrochemical cell in a metal can, a plastic pouch, or a laminated foil/plastic pouch.

In another aspect, a method of assembling an electrochemical cell with a gel electrolyte, comprises: (1) stacking a porous supporter, a positive electrode laminate, and a negative electrode laminate to form an electrochemical cell; (2) winding or folding the electrochemical cell to prepare a spiral wound cell type or a prismatic cell type; (3) putting the spiral wound or prismatic electrochemical cell in a metal can, a plastic pouch, or a laminated metal foil/plastic pouch; (4) injecting a gel electrolyte solution into the spiral wound or prismatic electrochemical cell in the metal can, plastic pouch, or laminated metal foil/plastic pouch wherein the gel electrolyte solution comprises at least one poly(ethyleneoxide) siloxane; at least one crosslinking agent; at least one monofunctional monomeric compound; at least one salt; and at least one radical reaction initiator; and (5) gelling the gel electrolyte solution to form the gel electrolyte.

In another aspect, a method of assembling an electrochemical cell with the gel electrolyte, comprises: (1) coating a gel electrolyte solution onto the surface of a positive or negative electrode laminate; wherein the gel electrolyte solution comprises at least one poly(ethyleneoxide) siloxane; at least one crosslinking agent; at least one monofunctional monomeric compound; at least one salt; and at least one radical reaction initiator; (2) gelling the gel electrolyte solution on the electrode laminate to form a gel electrolyte on the electrode laminate; (3) coating the gel electrolyte solution onto another negative or positive electrode laminate; (4) stacking the positive electrode laminate and negative electrode laminate to form an electrochemical cell; (5) winding or folding the electrochemical cell to form a spiral wound or a prismatic electrochemical cell; (6) curing the cell to gel any ungelled gel electrolyte solution into gel electrolyte; and (7) packaging the spiral wound or prismatic electrochemical cell in a metal can, a plastic pouch, or a laminated foil/plastic pouch.

### BRIEF DESCRIPTION OF THE DRAWINGS

FIG. 1 is a cyclic voltammogram of a gel electrolyte.

FIG. 2 is a graph of the capacity retention of a lithium-ion cell using one of the inventive gel electrolytes.

FIG. 3 is a graph of the capacity retention of a C/C double layer electrochemical capacitor using one of the inventive electrolytes.

### DETAILED DESCRIPTION

In one aspect, gel electrolytes are provided for use in battery applications. Such gel electrolytes comprise a poly(ethyleneoxide) siloxane, a crosslinking agent, a monofunctional monomeric compound, a salt, and a radical reaction initiator. The crosslinking agent and the monofunctional monomeric compound react in the presence of the initiator to form the gel. The poly(ethyleneoxide) siloxanes readily dissolve electrolyte additives such as tetraalkylammonium or lithium salts, and have the required low viscosity to transport the lithium ions. Batteries may be prepared using the gel electrolytes and methods of preparing or assembling electrochemical cells are provided. Such PEO siloxanes exhibit low glass transition temperatures leading to improved ionic conductivity at room temperatures.

For the purposes of this disclosure and unless otherwise specified, “a” or “an” means “one or more.”

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

BPO is an abbreviation for benzoylperoxide.

MCMB is an abbreviation for mesocarbon microbeads.

In general, “substituted” refers to an alkyl or alkenyl group, as defined below (e.g., an alkyl group) in which one or more bonds to a hydrogen atom contained therein are replaced by a bond to non-hydrogen or non-carbon atoms. Substituted groups also include groups in which one or more bonds to a carbon(s) or hydrogen(s) atom are replaced by one or more bonds, including double or triple bonds, to a heteroatom. Thus, a substituted group will be substituted with one or more substituents, unless otherwise specified. In some embodiments, a substituted group is substituted with 1, 2, 3, 4, 5, or 6 substituents. Examples of substituent groups include: halogens (i.e., F, Cl, Br, and I); hydroxyls; alkoxy, alkenoxy, alkynoxy, aryloxy, aralkyloxy, heterocyclyloxy, and heterocyclylalkoxy groups; carbonyls (oxo); carboxyls; esters; urethanes; oximes; hydroxylamines; alkoxyamines; aralkoxyamines; thiols; sulfides; sulfoxides; sulfones; sulfonyls; sulfonamides; amines; N-oxides; hydrazines; hydrazides; hydrazones; azides; amides; ureas; amidines; guanidines; enamines; imides; isocyanates; isothiocyanates; cyanates; thiocyanates; imines; nitro groups; nitriles (i.e., CN); and the like.

Alkyl groups include straight chain and branched alkyl groups having from 1 to 12 carbon atoms or, in some embodiments, from 1 to 8, 1 to 6, or 1 to 4 carbon atoms. Alkyl groups further include cycloalkyl groups as defined below. Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, tert-butyl, neopentyl, isopentyl, and 2,2-dimethylpropyl groups. Representative substituted alkyl groups may be substituted one or more times with substituents such as those listed above.

Cycloalkyl groups are cyclic alkyl groups such as, but not limited to, cyclopropyl, cyclobutyl, cyclopentyl, cyclohexyl, cycloheptyl, and cyclooctyl groups. In some embodiments, the cycloalkyl group has 3 to 8 ring members, whereas in other embodiments the number of ring carbon atoms range from 3 to 5, 3 to 6, or 3 to 7. Cycloalkyl groups further include mono-, bicyclic and polycyclic ring systems. Substituted cycloalkyl groups may be substituted one or more times with non-hydrogen and non-carbon groups as defined above. However, substituted cycloalkyl groups also include rings that are substituted with straight or branched chain alkyl groups as defined above. Representative substituted cycloalkyl groups may be mono-substituted or substituted more than once, such as, but not limited to, 2,2-, 2,3-, 2,4-2,5- or 2,6-disubstituted cyclohexyl groups, which may be substituted with substituents such as those listed above.

Alkenyl groups include straight and branched chain and cycloalkyl groups as defined above, except that at least one double bond exists between two carbon atoms. Thus, alkenyl groups have from 2 to about 12 carbon atoms in some embodiments, from 2 to 10 carbon atoms in other embodiments, and from 2 to 8 carbon atoms in other embodiments. Examples include, but are not limited to vinyl, allyl, —CH═CH(CH₃), —CH═C(CH₃)₂, —C(CH₃)═CH₂, —C(CH₃)═CH(CH₃), —C(CH₂CH₃)═CH₂, cyclohexenyl, cyclopentenyl, cyclohexadienyl, butadienyl, pentadienyl, and hexadienyl, among others. Representative substituted alkenyl groups may be mono-substituted or substituted more than once, such as, but not limited to, mono-, di- or tri-substituted with substituents such as those listed above.

The gel electrolytes embodied herein comprise a PEO siloxane liquid phase for lithium-ion transport and a crosslinked polymer that ensures mechanical strength and chemical stability of the gel electrolyte. The crosslinking phase can also assist in salt dissolution and transport.

PEO siloxanes have one or more PEO groups attached to the silicon atom. Such PEO siloxanes are stable, are incorporated in the polymer structure, and provide continuous conducting paths in all directions throughout the gel electrolyte. PEO siloxanes readily dissolve electrolyte additives such as tetraalkylammonium or lithium salts, and have the required low viscosity to transport the lithium ions. PEO siloxanes generally have PEO as side chains linked to the silicon atom. For example, PEO siloxanes may be generally described by Formulas Ia-Id:

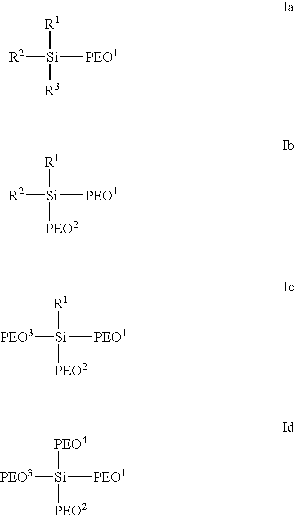

wherein R¹, R², and R³ are each independently hydrogen, a substituted or unsubstituted alkyl group having from 1 to 12 carbon atoms, a substituted or unsubstituted alkenyl group having from 2 to 12 carbon atoms, or a group of Formula IIa, IIb, IIc, or IId;

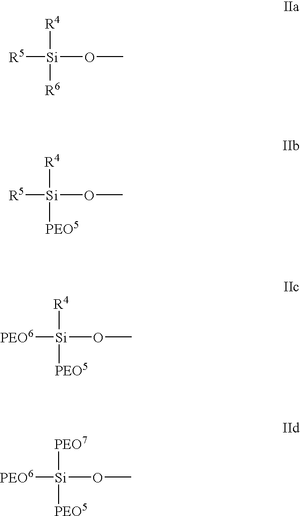

wherein, R⁴, R⁵, and R⁶ are each independently hydrogen, a substituted or unsubstituted alkyl group having from 1 to 12 carbon atoms, or a substituted or unsubstituted alkenyl group having from 2 to 12 carbon atoms; and PEO¹, PEO², PEO³, PEO⁴, PEO⁵, PEO⁶, and PEO⁷ are each independently a poly(ethyleneoxide) group.

In some embodiments, the poly(ethyleneoxide) siloxane is a compound of Formula Ib, Ic, or Id. In other embodiments, where the poly(ethyleneoxide) siloxane is a compound of Formula Ia and R¹ is a group of Formula IIa or IIb, then at least one of R², R³, R⁴, R⁵, and R⁶ is other than alkyl.

In some embodiments, PEO¹, PEO², PEO³, PEO⁴, PEO⁵, PEO⁶, and PEO⁷ are each independently represented by Formula IIIa or IIIb;

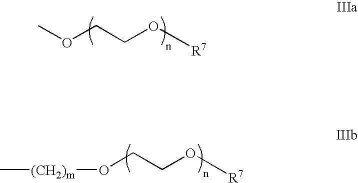

where R⁷ is a hydrogen, a substituted or unsubstituted alkyl group having from 1 to 12 carbon atoms, a substituted or unsubstituted alkenyl group having from 2 to 12 carbon atoms, or a group of Formula IV;

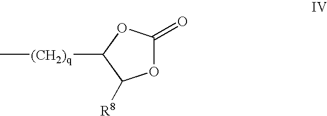

where R⁸ is hydrogen, a substituted or unsubstituted alkyl group having from 1 to 12 carbon atoms, or a substituted or unsubstituted alkenyl group having from 2 to 12 carbon atoms; m represents whole number from 1 to 8, n represents whole number from 0 to 20, and q represents whole number from 0 to 8. An exemplary poly(ethylene oxide) siloxane is 2-[2-[2-[2-methoxy]ethoxy]ethoxy]ethoxy trimethyl silane (1NM3), the structure of which is shown as Formula V:

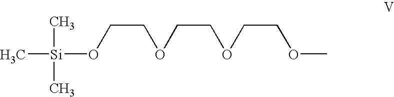

In some embodiments, the poly(ethyleneoxide) siloxane is present from about 5 wt % to about 95 wt %, wherein the wt % is calculated on the total weight of the at least one poly(ethyleneoxide) siloxane, the at least one crosslinking agent, the at least one monofunctional monomeric compound, the at least one salt, and the at least one radical reaction initiator. In some such embodiments, the poly(ethyleneoxide) siloxane is present from about 30 wt % to about 95 wt %. In other such embodiments, the poly(ethyleneoxide) siloxane is present from about 50 wt % to about 80 wt %.

In some embodiments, siloxanyl carbonates can be used as co-solvent with PEO siloxanes. For example, one such siloxanyl carbonate is 1-[1-trimethylsiloxanyl-ethyl]-ethylene carbonate (1NMC) the structure of which is shown as Formula VI:

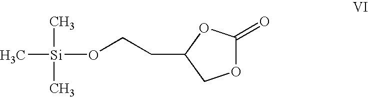

In some other embodiments, the content of the co-solvent is from about 0.1 wt % to about 80 wt %, wherein the wt % is calculated on the total weight of the at least one poly(ethyleneoxide) siloxane, the at least one crosslinking agent, the at least one monofunctional monomeric compound, the at least one salt, and the at least one radical reaction initiator. In some such embodiments, the content of the co-solvent is from about 1 wt % to about 70 wt %, from about 2 wt % to about 60 wt %, from about 3 wt % to about 50%, or from about 4 wt % to about 40 wt %.

Crosslinking agents suitable for use in the gel electrolyte of the present invention may be represented by a compound of Formula VII:

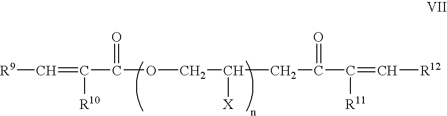

where R⁹, R¹⁰, R¹¹, and R¹² are each independently hydrogen, a substituted or unsubstituted alkyl group having from 1 to 12 carbon atoms, or a substituted or unsubstituted alkenyl group having from 2 to 12 carbon atoms; and where X is a hydrogen, methyl or ethyl group, and n represents a numeral 1 to 15, inclusive.

Monofunctional monomeric compounds may be used for the control of the crosslinking density of the gel electrolyte. Suitable monofunctional monomeric compounds include those of Formula VIII:

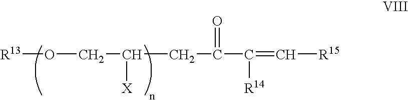

where R¹³ is an alkyl group having from 1 to 12 carbon atoms; R¹⁴ and R¹⁵ are each independently a hydrogen, a substituted or unsubstituted alkyl group having from 1 to 12 carbon atoms, or a substituted or unsubstituted alkenyl group having from 2 to 12 carbon atoms; X is hydrogen, methyl or ethyl group; and n represents a numeral from 1 to 20, inclusive.

Crosslinking agents and monofunctional monomeric compounds provide a physical framework, or gel, after crosslinking to host the liquid phase. Variation of the amount of the crosslinking agent and monofunctional monomeric compound in the gel may impact the conductivity of the gel electrolyte, due to changes in viscosity. Lower viscosity gels are prepared with higher concentrations of monofunctional monomeric compound, as compared to the concentration of monofunctional monomeric compound used for higher viscosity gels. Without being bound by theory, higher viscosity gels may be expected to have lower electrochemical conductivity, while lower viscosity gels may be expected to have higher electrochemical conductivity. However, other electrochemical properties of the gel electrolyte, or an electrochemical cell prepared with the gel electrolyte, such as oxidation potential and reduction potential, are not expected to be impacted.

In some embodiments, the content of the crosslinking agent is in the range of about 5 wt % to about 60 wt %, wherein the wt % is calculated on the total weight of the at least one poly(ethyleneoxide) siloxane, the at least one crosslinking agent, the at least one monofunctional monomeric compound, the at least one salt, and the at least one radical reaction initiator. In some such embodiments, the crosslinking agent is present from about 10 wt % to about 40 wt %, from about 15 wt % to about 35 wt %, or from about 20 wt % to about 30 wt %.

In other embodiments, the content of the monofunctional monomeric compound is in the range of about 10 wt % to about 50 wt %, wherein the wt % is calculated on the total weight of the at least one poly(ethyleneoxide) siloxane, the at least one crosslinking agent, the at least one monofunctional monomeric compound, the at least one salt, and the at least one radical reaction initiator. In some such embodiments, the monofunctional monomeric compound is in the range from about 15 wt % to about 40 wt %, from about 20 wt % to about 35 wt %, or from about 25 wt % to about 30 wt %.

Polymerization of crosslinking agents and monofunctional monomeric compounds are known to those of skill in the art. For example, these monomeric species may be polymerized by thermal and photo initiation. Representative thermal initiators include, but are not limited to, an azo compound, a peroxide compound, bismaleimide, or a mixture of any two or more thereof. One example of an azo compound is azoisobutyronitrile. One example of a peroxide compound is benzoylperoxide. Representative photoinitiators include, but are not limited to, 1-hydroxyl-phenyl-ketone, benzophenone, 2-hydroxyl-2-methyl-1-phenyl-propanone, 2-hydroxyl-1-[4-(2-hydroxy)phenyl]-2-methyl-1-propanone, methylbenzoylformate, oxy-phenyl-acetic acid 2-[2-oxo-2-phenyl-acetoxy-ethoxy]-ethyl ester, oxy-phenyl-acetic 2-[2-hydroxy-ethoxy]-ethyl ester, α,α-dimethoxy-α-phenylacetophenone, 2-benzyl-2-(dimethylamino)-1-[4-(4-morpholinyl)phenyl]-1-propanone, diphenyl (2,4,6-trimethylthio)phenyl)-phosphine oxide, phosphine oxide, phenyl bis(2,4,6-trimethyl benzoyl), bis(eta 5-2,4-cyclopentadien-1-yl)bis[2,6-difluoro-3-(1H-pyrrol-1-yl)phenyl]titanium, iodonium(4-methylphenyl)-[4-(2-methylpropyl)phenyl]-hexafluorophosphate, or a mixture of two or more thereof. In some instances the photoinitiator is a UV initiator.

As is known to those of skill in the art, monomers may also be polymerized by a combination of thermal and photoinitiation. Therefore, in some embodiments, the gel electrolyte comprises at least one thermal initiator and at lease one photoinitiator. In one such example, the gel electrolyte can be formed by curing with thermal initiation followed by UV radiation. In another example, the gel electrolyte can be formed by curing with UV radiation followed thermal initiation.

The salt to be used in the embodied gel electrolytes is not particularly limited, as long as it dissolves in the siloxane and serves as an electrolyte for an electrochemical device including batteries and capacitors. For example, salts that are suited for use in gel electrolytes include, but are not limited to, tetraalkylammonium (R¹⁶₄N⁺) salts of CF₃SO₃—, N(CF₃SO₂)²⁻, BF₄⁻, PF₆⁻, AsF₆⁻, or a mixture of any two or more thereof, or a lithium salt such as LiClO₄, LiBF₄, LiAsF₆, LiPF₆, Li[PF₂(C₂O₄)₂], Li[PF₄C₂O₄], Li[CF₃SO₃], Li[N(CF₃SO₂)₂], Li[C(CF₃SO₂)₃], Li[N(SO₂C₂F₅)₂], lithium alkyl fluorophosphates, Li[B(C₂O₄)₂] (‘LiBOB’), Li[BF₂(C₂O₄)], or a mixture of any two or more thereof, where R¹⁶ is an alkyl group having from 1 to 12 carbon atoms. Lithium (chelato)borates such as Li[B(C₂O₄)₂] and Li[BF₂(C₂O₄)], or lithium (chelato)phosphates such as Li[PF₂(C₂O₄)₂] and Li[PF₄(C₂O₄)] may also be used as the salt, or as an electrode stabilizing additive. Thus, in some embodiments, the salt may be other than Li[B(C₂O₄)₂], Li[BF₂(C₂O₄)], Li[PF₄(C₂O₄)] or Li[PF₂(C₂O₄)₂], and the electrolyte may include, as a electrode stabilizing additive, Li[B(C₂O₄)₂], Li[BF₂(C₂O₄)], Li[PF₂(C₂O₄)₂], Li[PF₄(C₂O₄)], or a mixture of any two or more thereof, at, e.g., from about 0.001 wt % to about 10 wt %. In some embodiments, the salt is an alkali metal salt such as a lithium salt.

The molar ratio of the salt to the oxygen in the mixture of siloxane, crosslinking agent, and monofunctional monomer is preferably from about 0.01 to about 0.3. If the proportion of the salt is smaller than 0.01, the ionic conductivity of the resulting gel electrolyte tends to decrease because of an inadequate number of carrier ions are in the gel electrolyte. If the molar ratio is greater than 0.3, the salt may not sufficiently dissociate in the resulting electrolyte, and the aggregation of ions, such as lithium ions, can act to reduce the ionic conductivity.

Electrolytes embodied herein may comprise electrode stabilizing additives that protect the electrodes from degradation. For example, co-pending U.S. patent application Ser. Nos. 10/857,365, filed on May 28, 2004; 11/297,120 filed on Dec. 8, 2005; and 11/338,902 filed on Jan. 24, 2006, list a number of stabilizing additives that may be used in the present gel electrolytes. Electrode stabilizing additives can be reduced or polymerized on the surface of a negative electrode to form a passivation film on the surface of negative electrode. Likewise, other electrode stabilizing additives can be oxidized or polymerized on the surface of the positive electrode to form a passivation film on the surface of the positive electrode. In some embodiments electrolytes of the invention further include mixtures of the two types of electrode stabilizing additives. The additives are typically present at a concentration of about 0.001 to about 10 wt %.

Representative electrode stabilizing additives include, but are not limited to, pyridazine, vinyl pyridazine, quinoline, vinyl quinoline, pyridine, vinyl pyridine, indole, vinyl indole, triethanolamine, 1,3-dimethyl butadiene, butadiene, vinyl ethylene carbonate, vinyl carbonate, imidazole, vinyl imidazole, piperidine, vinyl piperidine, pyrimidine, vinyl pyrimidine, pyrazine, vinyl pyrazine, isoquinoline, vinyl isoquinoline, quinoxaline, vinyl quinoxaline, biphenyl, 1,2-diphenyl ether, 1,2-diphenylethane, o-terphenyl, N-methylpyrrole, naphthalene, 3,9-divinyl-2,4,8,10-tetraoxaspiro[5,5]undecane, 3,9-divinyl-2,4,8-trioxaspiro[5,5]undecane, 3,9-divinyl-2,4-dioxaspiro[5,5]undecane, 3,9-diethylidene-2,4,8,10-tetraoxaspiro[5,5]undecane, 3,9-diethylidene-2,4,8-trioxaspiro[5,5]undecane, 3,9-diethylidene-2,4-dioxaspiro[5,5]undecane, 3,9-dimethylene-2,4,8,10-tetraoxaspiro[5,5]undecane, 3,9-divinyl-1,5,7,11-tetraoxaspiro[5,5]undecane, 3,9-dimethylene-1,5,7,11-tetraoxaspiro[5,5]undecane, 3,9 diethylidene-1,5,7,11-tetraoxaspiro[5,5]undecane, or a mixture of any two or more thereof.

Other electrode stabilizing additives include, but are not limited to, substituted or unsubstituted spirocyclic hydrocarbons containing at least one oxygen atom and at least one alkenyl or alkynyl group. For example, such spirocyclic hydrocarbons include those having Formula IX:

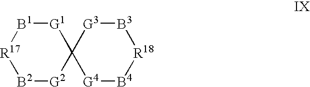

wherein, B¹, B², B³, and B⁴ are independently O or CR¹⁹R²⁰; provided that B¹ is not O when G¹ is O, B² is not O when G² is O, B³ is not O when G³ is O, and B⁴ is not O when G⁴ is O; G¹, G², G³, and G⁴ are independently O or CR¹⁹R²⁰; provided that G¹ is not O when B¹ is O, G² is not O when B² is O, G³ is not O when B³ is O, and G⁴ is not O when B⁴ is O; R¹⁷ and R¹⁸ are independently a substituted or unsubstituted divalent alkenyl or alkynyl group; R¹⁹ and R²⁰ at each occurrence are independently H, F, Cl, a substituted or an unsubstituted alkyl, alkenyl, or alkynyl group.

Representative examples of Formula IX include, but are not limited to, 3,9-divinyl-2,4,8,10-tetraoxaspiro[5,5]undecane, 3,9-divinyl-2,4,8-trioxaspiro[5,5]undecane, 3,9-divinyl-2,4-dioxaspiro[5,5]undecane, 3,9-diethylidene-2,4,8,10-tetraoxaspiro[5,5]undecane, 3,9 diethylidene-2,4,8-trioxaspiro[5,5]undecane, 3,9-diethylidene-2,4-dioxaspiro[5,5]undecane, 3,9-dimethylene-2,4,8,10-tetraoxaspiro[5,5]undecane, 3,9-divinyl-1,5,7,11-tetraoxaspiro[5,5]undecane, 3,9-dimethylene-1,5,7,11-tetraoxaspiro[5,5]undecane, 3,9 diethylidene-1,5,7,11-tetraoxaspiro[5,5]undecane, or a mixture of any two or more thereof.

Other suitable electrode stabilizing additives include, but are not limited to, those electrode stabilizing additives that reduce the interfacial impedance of the electrochemical devices. For example, such additives may be an anion receptor, including those having Formula X:

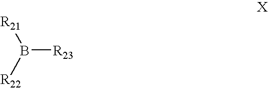

wherein, R²¹, R²², and R²³ are independently halogen, alkyl, aryl, halogen-substituted alkyl, halogen-substituted aryl, or OR²⁴; or any two of R²¹, R²², R²³, and R²⁴, together with the atoms to which they are attached, form a heterocyclic ring having 5-9 members, and R²⁴ is at each occurrence independently alkyl, aryl, halogen-substituted alkyl, or halogen-substituted aryl. In some such embodiments, R²¹, R²², and R²³ are independently halogen, alkyl, aryl, halogen-substituted alkyl, or halogen-substituted aryl; or any two of R²¹, R²², and R²³, together with the boron to which they are attached, form a heterocyclic ring having 5-9 members.

Representative anion receptors include, but are not limited to, tri(propyl)borate, tris(1,1,1,3,3,3-hexafluoro-propan-2-yl)borate, tris(1,1,1,3,3,3-hexafluoro-2-phenyl-propan-2-yl)borate, tris(1,1,1,3,3,3-hexafluoro-2-(trifluoromethyl)propan-2-yl)borate, triphenyl borate, tris(4-fluorophenyl)borate, tris(2,4-difluorophenyl)borate, tris(2,3,5,6-tetrafluorophenyl)borate, tris(pentafluorophenyl)borate, tris(3-(trifluoromethyl)phenyl)borate, tris(3,5-bis(trifluoromethyl)phenyl)borate, tris(pentafluorophenyl)borane, or a mixture of any two or more thereof. Further suitable additives include 2-(2,4-difluorophenyl)-4-fluoro-1,3,2-benzodioxaborole, 2-(3-trifluoromethyl phenyl)-4-fluoro-1,3,2-benzodioxaborole, 2,5-bis(trifluoromethyl)phenyl-4-fluoro-1,3,2-benzodioxaborole, 2-(4-fluorophenyl)-tetrafluoro-1,3,2-benzodioxaborole, 2-(2,4-difluorophenyl)-tetrafluoro-1,3,2-benzodioxaborole, 2-(pentafluorophenyl)-tetrafluoro-1,3,2-benzodioxaborole, 2-(2-trifluoromethyl phenyl)-tetrafluoro-1,3,2-benzodioxaborole, 2,5-bis(trifluoromethyl phenyl)-tetrafluoro-1,3,2-benzodioxaborole, 2-phenyl-4,4,5,5-tetra(trifluoromethyl)-1,3,2-benzodioxaborolane, 2-(3,5-difluorophenyl-4,4,5,5-tetrakis(trifluoromethyl)-1,3,2-dioxaborolane, 2-(3,5-difluorophenyl-4,4,5,5-tetrakis(trifluoromethyl)-1,3,2-dioxaborolane, 2-pentafluorophenyl-4,4,5,5-tetrakis(trifluoromethyl)-1,3,2-dioxaborolane, bis(1,1,1,3,3,3-hexafluoroisopropyl)phenyl-boronate, bis(1,1,1,3,3,3-hexafluoroisopropyl)-3,5-difluorophenylboronate, bis(1,1,1,3,3,3-hexafluoroisopropyl)pentafluorophenylboronate, or a mixture of any two or more thereof.

The preparation of the gel electrolytes may be accomplished via a number of methods. For example, in one such embodiment, a method for preparing a gel electrolyte, comprises the steps of: (1) dissolving a lithium salt and a thermal initiator in a PEO siloxane; (2) mixing two or more acrylate terminated polyalkylether monomers (at least one as crosslinking agent and at least one as monofunctional monomeric compound) comprising either or both of an ethylene oxide unit and a propylene oxide unit as a monomeric unit in the resulting solution; (3) casting the resulting mixture onto a substrate, and (4) heating the cast film until solidified. Substrates used in such methods can be a porous medium such as a polyolefin separator, a polyolefin nonwoven type separator, a polycarbonate microporous membrane, or the surface of an electrode.

Substrates may be used to reduce the thickness of gel electrolytes necessary for device fabrication, by providing additional structural content to the device and electrode separation. The final thickness of the gel electrolyte on an individual substrate may be below about 100 μm, or below about 90 μm, or below about 80 μm, or below about 70 μm, or below about 60 μm, or below about 50 μm, or below about 40 μm, or below about 30 μm, or below about 20 μm, or below about 10 μm, or greater than 1 μm. In some cases the final thickness of the gel electrolyte on an individual substrate may be from about 1 μm to about 100 μm, from about 1 μm to about 90 μm, from about 1 μm to about 80 μm, from about 1 μm to about 70 μm, from about 1 μm to about 60 μm, from about 1 μm to about 50 μm, from about 5 μm to about 100 μm, from about 5 μm to about 50 μm, from about 10 μm to about 100 μm, or from about 10 μm to about 50 μm.

The present invention also embodies electrochemical cells comprising the gel electrolyte disclosed herein, and at least one electrode. In some embodiments, the electrochemical cell is a lithium-ion rechargeable cell. In other embodiments, the electrochemical cell is a capacitor. In other such embodiments, the capacitor is a double layer electrochemical capacitor.

Electrochemical cells embodied herein may also be assembled by a variety of methods. One such method for assembling an electrochemical cell with the gel electrolyte, comprises the steps of: (1) coating a gel electrolyte solution onto the surface of a porous supporter, a positive electrode laminate, and a negative electrode laminate, wherein the gel electrolyte solution comprises at least one poly(ethyleneoxide) siloxane; at least one crosslinking agent; at least one monofunctional monomeric compound; at least one salt; and at least one radical reaction initiator; (2) gelling the solution to produce the gel electrolyte; (3) stacking the coated supporter, the coated positive electrode laminate, and the coated negative electrode laminate to form an electrochemical cell; (4) winding or folding the stacked electrochemical cell to prepare a spiral wound cell type or prismatic cell type; and (5) packaging the spiral wound or prismatic electrochemical cell in a metal can, a plastic pouch, or a laminated plastic/metal foil pouch. Such stacking, winding and packaging are well known in the art.

Another method for assembling an electrochemical cell with the gel electrolytes embodied herein, comprises the steps of: (1) coating a gel electrolyte solution onto the surface of a porous supporter, a positive electrode laminate, and a negative electrode laminate, wherein the gel electrolyte solution comprises at least one poly(ethyleneoxide) siloxane; at least one crosslinking agent; at least one monofunctional monomeric compound; at least one salt; and at least one radical reaction initiator; (2) stacking the coated supporter, the coated positive electrode laminate, and the coated negative electrode laminate to form an electrochemical cell; (3) winding or folding the electrochemical cell to prepare a spiral wound cell type or a prismatic cell type; (4) gelling the solution to form the gel electrolyte; and (5) packaging the spiral wound or prismatic electrochemical cell in a metal can, a plastic pouch, or a laminated foil/plastic pouch.

Another method for assembling an electrochemical cell with the gel electrolyte embodied herein, comprises the steps of: (1) stacking a porous supporter, a positive electrode laminate, and a negative laminate to form an electrochemical cell; (2) winding or folding the electrochemical cell to prepare a spiral wound cell type or a prismatic cell type; (3) putting the spiral wound or prismatic electrochemical cell in a metal can, a plastic pouch, or a laminated metal foil/plastic pouch; (4) injecting a gel electrolyte solution into the spiral wound or prismatic electrochemical cell in the metal can, plastic pouch, or laminated metal foil/plastic pouch, wherein the gel electrolyte solution comprises at least one poly(ethyleneoxide) siloxane; at least one crosslinking agent; at least one monofunctional monomeric compound; at least one salt; and at least one radical reaction initiator; and (5) gelling the solution to form a gel electrolyte.

Yet another method for assembling an electrochemical cell with the gel electrolytes embodied herein, comprises the steps of: (1) coating a gel electrolyte onto the surface of a positive or negative electrode laminate, wherein the gel electrolyte solution comprises at least one poly(ethyleneoxide) siloxane; at least one crosslinking agent; at least one monofunctional monomeric compound; at least one salt; and at least one radical reaction initiator; (2) gelling the gel electrolyte solution on the electrode laminate to form a gel electrolyte; (3) coating the gel electrolyte solution onto another electrode laminate; (4) stacking the positive electrode laminate and the negative electrode laminate to form an electrochemical cell; (5) winding or folding the electrochemical cell to form a spiral wound cell type or a prismatic cell type; (6) curing the cell to gel any ungelled gel electrolyte solution into gel electrolyte; and (7) packaging the spiral wound or prismatic electrochemical cell in a metal can, a plastic pouch, or a laminated foil/plastic pouch.

One skilled in the art will readily realize that all ranges and ratios discussed can and do necessarily also describe all subranges and subratios therein for all purposes and that all such subranges and subratios also form part and parcel of this invention. Any listed range or ratio can be easily recognized as sufficiently describing and enabling the same range or ratio being broken down into at least equal halves, thirds, quarters, fifths, tenths, etc. As a non-limiting example, each range or ratio discussed herein can be readily broken down into a lower third, middle third and upper third, etc.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

The present invention will be better understood by reference to the following examples which are intended for purposes of illustration and are not intended to nor are to be interpreted in any way as limiting the scope of the present invention, which is defined in the claims appended hereto.

### EXAMPLES

### Example 1

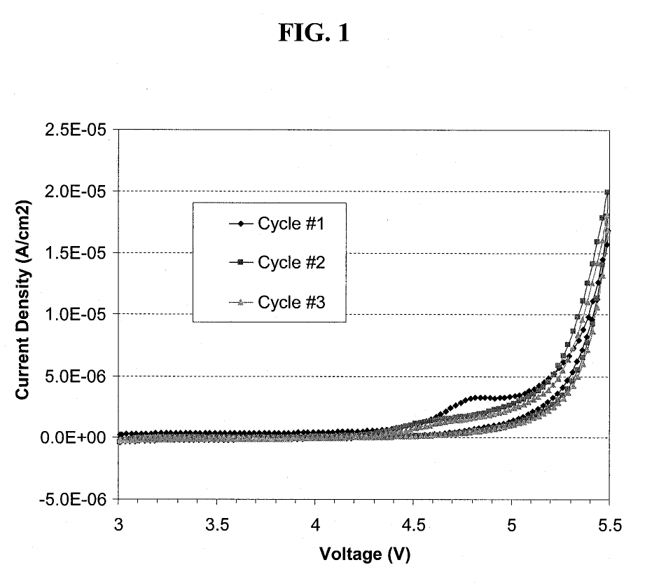

FIG. 1 shows the cyclic voltammogram of a gel electrolyte comprising 20 wt % of poly(ethyleneglycol)dimethacrylate, 20 wt % poly(ethylene glycol) ethyl ether methacrylate, 59.7 wt % siloxane electrolyte and 0.3 wt % BPO. The siloxane electrolyte used is 0.8 M LiBOB dissolved in a mixture of 1NM3 and 1NMC (3:2 by weight). Clearly, the inventive electrolyte has a wide voltage window up to 4.5 V vs. Li⁺/Li.

### Example 2

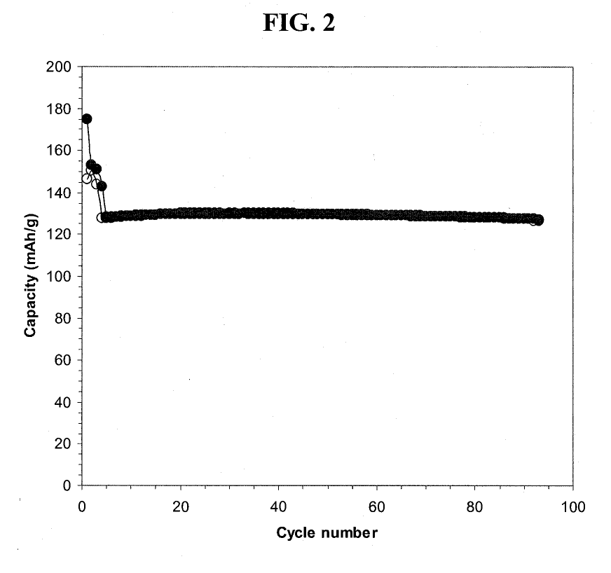

FIG. 2 shows the capacity retention of an MCMB/LiNi_{0.8}Co_{0.15}Al_{0.05}O₂ lithium-ion cell using the inventive gel electrolyte comprising 20 wt % of poly(ethyleneglycol)dimethacrylate, 20 wt % poly(ethylene glycol) ethyl ether methacrylate, 59.7 wt % siloxane electrolyte and 0.3 wt % BPO. The siloxane electrolyte used is 0.8 M LiBOB dissolved in a mixture of 1NM3 and 1NMC (3:2 by weight). The cell showed no capacity fade up to 100 cycles.

### Example 3

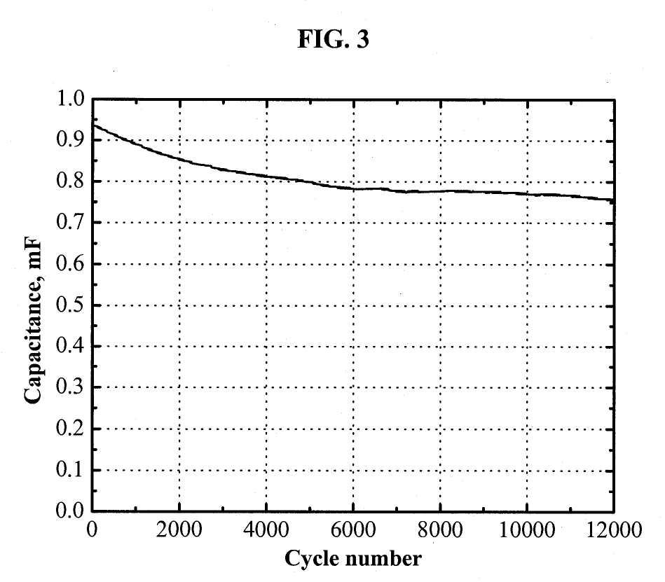

FIG. 3 shows the capacity retention of a carbon/carbon double layer electrochemical capacitor using the inventive gel electrolyte comprising 20 wt % of poly(ethyleneglycol)dimethacrylate, 20 wt % poly(ethylene glycol) ethyl ether methacrylate, 59.7 wt % siloxane electrolyte and 0.3 wt % BPO. The siloxane electrolyte used is 0.8 M LiBOB dissolved in a mixture of 1NM3 and 1NMC (3:2 by weight). The cell was cycled between 0 and 3.0 V. Excellent capacity retention was obtained for 12000 cycles.

While several, non-limiting examples have been illustrated and described, it should be understood that changes and modifications can be made therein in accordance with ordinary skill in the art without departing from the invention in its broader aspects as defined in the following claims.

What is claimed is:

1. A gel electrolyte comprising:
at least one poly(ethyleneoxide) siloxane;
at least one crosslinking agent;
at least one monofunctional monomeric compound;
at least one salt;
and at least one radical reaction initiator;
wherein the poly(ethyleneoxide) siloxane is a compound of Formula Ia, Ib, Ic, Id, or a mixture of any two or more thereof: 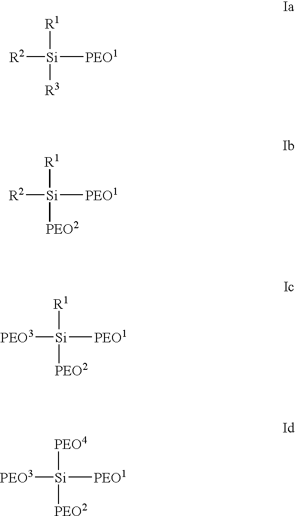
wherein
R¹, R², and R³ are each independently hydrogen, a substituted or unsubstituted alkyl group having from 1 to 12 carbon atoms, a substituted or unsubstituted alkenyl group having from 2 to 12 carbon atoms, or a group of Formula IIa, IIb, IIc, or IId; 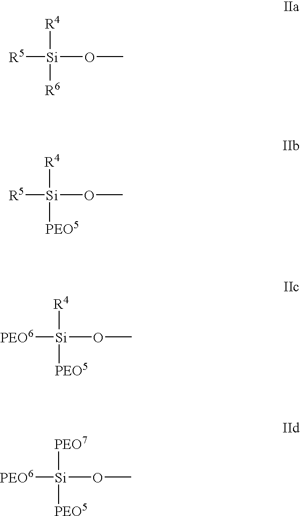
wherein,
R⁴, R⁵, and R⁶ are each independently hydrogen, a substituted or unsubstituted alkyl group having from 1 to 12 carbon atoms, or a substituted or unsubstituted alkenyl group having from 2 to 12 carbon atoms; and
PEO¹, PEO², PEO³, PEO⁴, PEO⁵, PEO⁶, and PEO⁷ are each independently a poly(ethyleneoxide) group; with the proviso that when the poly(ethyleneoxide) siloxane is a compound of Formula Ia and R¹ is a group of Formula IIa or IIb, then at least one of R², R³, R⁴, R⁵, and R⁶ is other than alkyl.

2. The gel electrolyte of claim 1, wherein the poly(ethyleneoxide) siloxane is a compound of Formula Ib, Ic, or Id.

3. The gel electrolyte of claim 1, wherein PEO¹, PEO², PEO³, and PEO⁴ are each independently represented by Formula IIIa or IIIb; 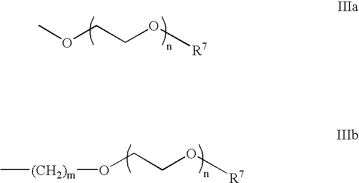
wherein
R⁷ is a hydrogen, a substituted or unsubstituted alkyl group having from 1 to 12 carbon atoms, a substituted or unsubstituted alkenyl group having from 2 to 12 carbon atoms, or a group of Formula IV; 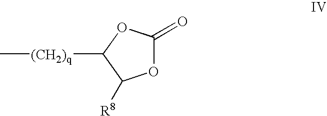
R⁸ is hydrogen, a substituted or unsubstituted alkyl group having from 1 to 12 carbon atoms, or a substituted or unsubstituted alkenyl group having from 2 to 12 carbon atoms;
m represents a whole number from 1 to 8,
n represents a whole number from 0 to 20, and
q represents a whole number from 0 to 8.

4. The gel electrolyte of claim 1, further comprising a siloxanyl carbonate co-solvent.

5. The gel electrolyte of claim 4, wherein the co-solvent is 1-[1-trimethylsiloxanylethyl]ethylene carbonate.

6. The gel electrolyte of claim 1, wherein the poly(ethyleneoxide) siloxane is 2-[2-[2-[2-methoxy]ethoxy]ethoxy]ethoxy trimethyl silane.

7. The gel electrolyte of claim 1, wherein the crosslinking agent is a compound of Formula VII: 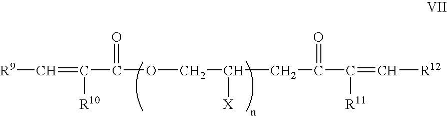
wherein,
R⁹, R¹⁰, R¹¹, and R¹² are each independently hydrogen, a substituted or unsubstituted alkyl group having from 1 to 12 carbon atoms, or a substituted or unsubstituted alkenyl group having from 2 to 12 carbon atoms;
X is hydrogen, methyl, or ethyl; and
n is a whole number from 1 to 15.

8. The gel electrolyte of claim 1, wherein the monofunctional monomeric compound is a compound of Formula VIII: 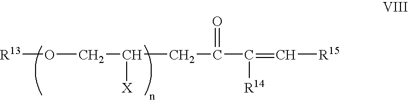
wherein,
R¹³ is an alkyl group having from 1 to 12 carbon atoms;
R¹⁴ and R¹⁵ are each independently a hydrogen, a substituted or unsubstituted alkyl group having from 1 to 12 carbon atoms, or a substituted or unsubstituted alkenyl group having from 2 to 12 carbon atoms;
X is hydrogen, methyl, or ethyl; and
n is a whole number from 1 to 20.

9. The gel electrolyte of claim 1, wherein the poly(ethyleneoxide) siloxane is present from about 5 wt % to about 95 wt %, wherein the wt % is calculated on the total weight of the at least one poly(ethyleneoxide) siloxane, the at least one crosslinking agent, the at least one monofunctional monomeric compound, the at least one salt, and the at least one radical reaction initiator.

10. The gel electrolyte of claim 1, wherein the crosslinking agent is present from about 5 wt % to about 60 wt %, wherein the wt % is calculated on the total weight of the at least one poly(ethyleneoxide) siloxane, the at least one crosslinking agent, the at least one monofunctional monomeric compound, the at least one salt, and the at least one radical reaction initiator.

11. The gel electrolyte of claim 1, wherein the monofunctional monomeric compound is present from about 10 wt % to about 50 wt %, wherein the wt % is calculated on the total weight of the at least one poly(ethyleneoxide) siloxane, the at least one crosslinking agent, the at least one monofunctional monomeric compound, the at least one salt, and the at least one radical reaction initiator.

12. The gel electrolyte of claim 1, wherein the at least one salt is a lithium salt selected from LiClO₄, LiBF₄, LiAsF₆, LiPF₆, Li[PF₂(C₂O₄)₂], Li[PF₄(C₂O₄)], Li[CF₃SO₃], Li[N(CF₃SO₂)₂], Li[C(CF₃SO₂)₃], Li[N(SO₂C₂F₅)₂], a lithium alkyl fluorophosphate, Li[B(C₂O₄)₂], Li[BF₂(C₂O₄)], or a mixture of any two or more thereof.

13. The gel electrolyte of claim 1, wherein the at least one radical reaction initiator is a thermal initiator, a photoinitiator, or a mixture thereof, wherein the thermal initiator is an azo compound, a peroxide compound, bismaleimide, or a mixture of any two or more thereof; and the photoinitiator is 1-hydroxyl-phenyl-ketone, benzophenone, 2-hydroxyl-2-methyl-1-phenyl-propanone, 2-hydroxyl-1-[4-(2-hydroxy)phenyl]-2-methyl-1-propanone, methylbenzoylformate, oxy-phenyl-acetic acid 2-[2-oxo-2-phenyl-acetoxy-ethoxy]-ethyl ester, oxy-phenyl-acetic 2-[2-hydroxy-ethoxy]-ethyl ester, α,α-dimethoxy-α-phenylacetophenone, 2-benzyl-2-(dimethylamino)-1-[4-(4-morpholinyl)phenyl]-1-propanone, diphenyl (2,4,6-trimethylthio)phenyl)-phosphine oxide, phosphine oxide, phenyl bis(2,4,6-trimethyl benzoyl), bis(eta 5-2,4-cyclopentadien-1-yl)bis[2,6-difluoro-3-(1H-pyrrol-1-yl)phenyl]titanium, iodonium (4-methylphenyl)-[4-(2-methylpropyl)phenyl]-hexafluorophosphate, or a mixture of any two or more thereof.

14. The gel electrolyte of claim 1, wherein the gel electrolyte is incorporated into a porous medium selected from a polyolefin separator, a polyolefin nonwoven type separator, or a polycarbonate microporous membrane.

15. The gel electrolyte of claim 1, further comprising at least one electrode stabilizing additive, wherein the electrode stabilizing additive can be oxidized or polymerized on the surface of positive electrodes, or can be reduced or polymerized on the surface of negative electrodes.

16. An electrochemical cell comprising the gel electrolyte of claim 1 and at least one electrode.

17. The electrochemical cell of claim 16, wherein the electrochemical cell is a lithium-ion rechargeable cell or a capacitor.

18. A method of preparing a gel electrolyte comprising:
(1) dissolving a lithium salt and a thermal initiator in a poly(ethylene oxide) siloxane to form a first solution;
(2) adding two or more acrylate terminated polyalkylether compounds to the first solution, to form a second solution wherein acrylate terminated polyalkylether compounds comprise an ethylene oxide unit, a propylene oxide unit, or both;
(3) casting the second solution onto a substrate, and
(4) heating the second solution and substrate until the second solution is solidified.

19. A method of assembling an electrochemical cell with a gel electrolyte, comprising:
(1) stacking a porous supporter, a positive electrode laminate, and a negative electrode laminate to form an electrochemical cell;
(2) winding or folding the electrochemical cell to prepare a spiral wound cell type or a prismatic cell type;
(3) putting the spiral wound or prismatic electrochemical cell in a metal can, a plastic pouch, or a laminated metal foil/plastic pouch;
(4) injecting a gel electrolyte solution into the spiral wound or prismatic electrochemical cell in the metal can, plastic pouch, or laminated metal foil/plastic pouch
wherein the gel electrolyte solution comprises at least one poly(ethyleneoxide) siloxane;
at least one crosslinking agent;
at least one monofunctional monomeric compound;
at least one salt; and
at least one radical reaction initiator; and
(5) gelling the gel electrolyte solution to form the gel electrolyte.
